(19) United States
(12) Patent Application Publication
(10) Pub. No.: US 2014/0204961 A1
(43) Pub. Date: Jul. 24, 2014

(54) Signaling

(71) Applicants: Kari Juhani Hooli, Oulu (FI); Kari Pekka Pajukoshi, Oulu (FI); Esa Tapani Tiirola, Kempele (FI)

(72) Inventors: Kari Juhani Hooli, Oulu (FI); Kari Pekka Pajukoshi, Oulu (FI); Esa Tapani Tiirola, Kempele (FI)

(73) Assignee: NOKIA SOLUTIONS AND NETWORKS OY, Espoo (FI)

(21) Appl. No.: 14/238,518

(22) PCT Filed: Aug. 15, 2011
(86) PCT No.: PCT/EP2011/064008

§ 371 Date: Feb. 12, 2014

(51) Int. Cl. H04L 29/08; H04L 29/06; H04L 5/00

(52) U.S. Cl. CPC H04L 69/324; H04L 5/0048; H04L 5/0053; H04L 69/28
USPC 370/476

(57) ABSTRACT

The invention relates to an apparatus including at least one processor and at least one memory including a computer program code, the at least one memory and the computer program code configured to, with the at least one processor, cause the apparatus at least to: choose more than one subframes from subframes targeted to at least two of the following: physical uplink control channel acknowledgement/no-acknowledgement signaling, physical hybrid automatic repeat request indicator channel acknowledgement/no-acknowledgement signaling, physical uplink shared channel resource allocation grant signaling, physical downlink shared channel resource allocation grant signaling, and form a periodic signaling pattern to obtain a flexible subframe configuration for uplink and downlink signaling by using the chosen more than one subframes.

### FIELD

The Invention Relates To Apparatuses, Methods, a System, Computer Programs, Computer program products and computer-readable media.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

Long term evolution (LTE) and long term evolution advanced (LTE-A) have been defined to accommodate both paired spectrum for Frequency division duplex, FDD and unpaired spectrum for Time division duplex, TDD operation. LTE-TDD is also known as TD-LTE. One design target has been to maximize commonality between the LTE-TDD and LTE-FDD to minimize joint standardization and implementation effort, and to maximize compatibility, and thus coexistence of these two LTE modes in a same communication system. Additionally, the LTE-TDD is made compatible also with Time division synchronous code division multiple access (TD-SCDMA).

### BRIEF DESCRIPTION

According to an aspect of the present invention, there is provided an apparatus comprising: at least one processor and at least one memory including a computer program code, the at least one memory and the computer program code configured to, with the at least one processor, cause the apparatus at least to: choose at least one more than one subframes from subframes targeted to at least two one of the following: physical uplink control channel acknowledgement/no-acknowledgement signaling, physical hybrid automatic repeat request indicator channel acknowledgement/no-acknowledgement signaling, and physical uplink shared channel resource allocation grant signaling, physical downlink shared channel resource allocation grant signaling, and form a periodic signaling pattern to obtain a flexible subframe configuration for uplink and downlink signaling for uplink and downlink signaling by using the chosen more than one subframes.

According to yet another aspect of the present invention, there is provided a method comprising: choosing more than one subframes from subframes targeted to at least two of the following: physical uplink control channel acknowledgement/no-acknowledgement signaling, physical hybrid automatic repeat request indicator channel acknowledgement/no-acknowledgement signaling, physical uplink shared channel resource allocation grant signaling, physical downlink shared channel resource allocation grant signaling, and forming a periodic signaling pattern to obtain a flexible subframe configuration for uplink and downlink signaling by using the chosen more than one subframes.

According to yet another aspect of the present invention, there is provided an apparatus comprising: means for choosing more than one subframes from subframes targeted to at least two of the following: physical uplink control channel acknowledgement/no-acknowledgement signaling, physical hybrid automatic repeat request indicator channel acknowledgement/no-acknowledgement signaling, physical uplink shared channel resource allocation grant signaling, physical downlink shared channel resource allocation grant signaling, and means for forming a periodic signaling pattern to obtain a flexible subframe configuration for uplink and downlink signaling by using the chosen more than one subframes.

According to yet another aspect of the present invention, there is provided a computer program embodied on a computer-readable storage medium, the computer program comprising program code for controlling a process to execute a process, the process comprising: choosing more than one subframes from subframes targeted to at least two of the following: physical uplink control channel acknowledgement/no-acknowledgement signaling, physical hybrid automatic repeat request indicator channel acknowledgement/no-acknowledgement signaling, physical uplink shared channel resource allocation grant signaling, physical downlink shared channel resource allocation grant signaling, and forming a periodic signaling pattern to obtain a flexible subframe configuration for uplink and downlink signaling by using the chosen more than one subframes.

### LIST OF DRAWINGS

Some embodiments of the present invention are described below, by way of example only, with reference to the accompanying drawings, in which

FIG. 1 illustrates an example of a system;

FIG. 2 is a flow chart;

FIG. 3 illustrates an example of timing;

FIG. 4 illustrates another example of timing;

FIG. 5 illustrates yet another example of timing;

FIG. 6 illustrates yet another example of timing;

FIG. 7 illustrates yet another example of timing, and

FIG. 8 illustrates examples of apparatuses.

### DESCRIPTION OF EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments are applicable to any user device, such as a user terminal, relay node, server, node, corresponding component, and/or to any communication system or any combination of different communication systems that support required functionalities. The communication system may be a wireless communication system or a communication system utilizing both fixed networks and wireless networks. The protocols used, the specifications of communication systems, apparatuses, such as servers and user terminals, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of an access architecture to which the embodiments may be applied, a radio access architecture based on long term evolution advanced (LTE Advanced, LTE-A) that is based on orthogonal frequency multiplexed access (OFDMA) in a downlink and a single-carrier frequency-division multiple access (SC-FDMA) in an uplink, without restricting the embodiments to such an architecture, however. It is obvious for a person skilled in the art that the embodiments may also be applied to other kinds of communications networks having suitable means by adjusting parameters and procedures appropriately.

In an orthogonal frequency division multiplexing (OFDM) system, the available spectrum is divided into multiple orthogonal sub-carriers. In OFDM systems, available bandwidth is divided into narrower sub-carriers and data is transmitted in parallel streams. Each OFDM symbol is a linear combination of signals on each of the subcarriers. Further, each OFDM symbol is preceded by a cyclic prefix (CP), which is used to decrease Inter-Symbol Interference. Unlike in OFDM, SC-FDMA subcarriers are not independently modulated.

Typically, a (e)NodeB (“e” stands for evolved) needs to know channel quality of each user device and/or the preferred precoding matrices (and/or other multiple input-multiple output (MIMO) specific feedback information, such as channel quantization) over the allocated sub-bands to schedule transmissions to user devices. Required information is usually signalled to the (e)NodeB.

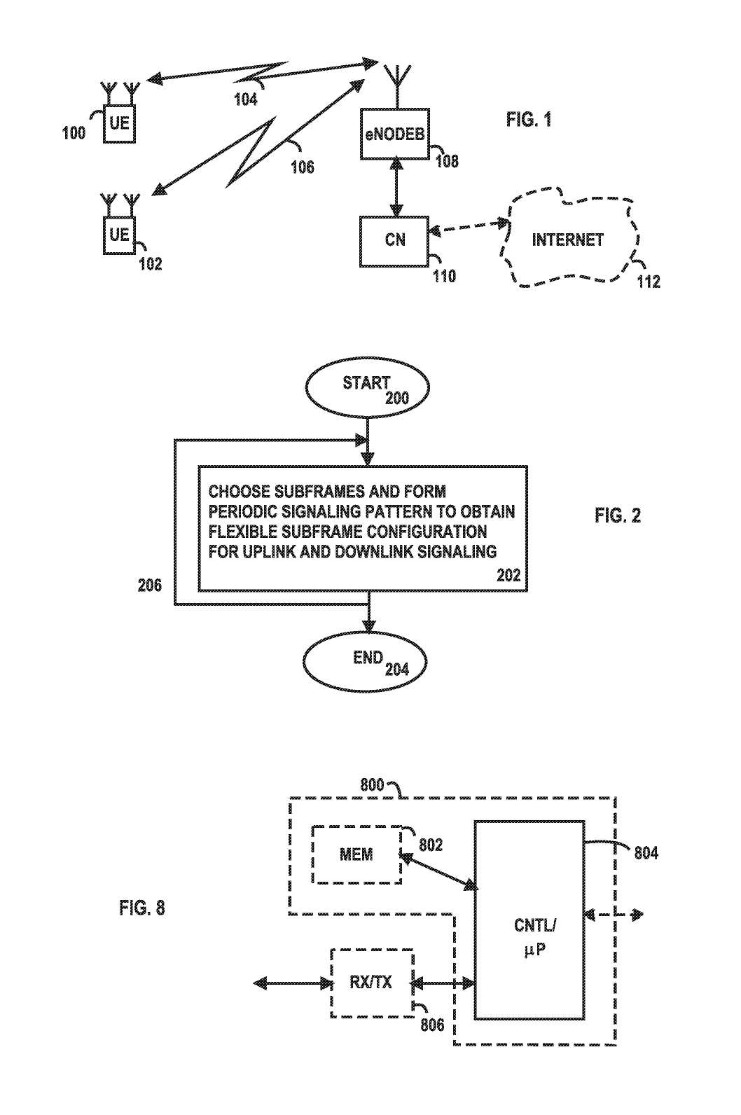

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

FIG. 1 shows a part of a radio access network based on E-UTRA, LTE, LTE-Advanced (LTE-A) or LTE/EPC (EPC=evolved packet core, EPC is enhancement of packet switched technology to cope with faster data rates and growth of Internet protocol traffic). E-UTRA is an air interface of Release 8 (UTRA=UMTS terrestrial radio access, UMTS=universal mobile telecommunications system). Some advantages obtainable by LTE (or E-UTRA) are a possibility to use plug and play devices, and Frequency Division Duplex (FDD) and Time Division Duplex (TDD) in the same platform.

FIG. 1 shows user devices 100 and 102 configured to be in a wireless connection on one or more communication channels 104, 106 in a cell with a (e)NodeB 108 providing the cell. The physical link from a user device to a (e)NodeB is called uplink or reverse link and the physical link from the NodeB to the user device is called downlink or forward link.

The NodeB, or advanced evolved node B (eNodeB, eNB) in LTE-Advanced, is a computing device configured to control the radio resources of communication system it is coupled to. The (e)NodeB may also be referred to a base station, an access point or any other type of interfacing device including a relay station capable of operating in a wireless environment.

The (e)NodeB includes transceivers, for example. From the transceivers of the (e)NodeB, a connection is provided to an antenna unit that establishes bi-directional radio links to user devices. The antenna unit may comprise a plurality of antennas or antenna elements. The (e)NodeB is further connected to core network 110 (CN). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

A communications system typically comprises more than one (e)NodeB in which case the (e)NodeBs may also be configured to communicate with one another over links, wired or wireless, designed for the purpose. These links may be used for signalling purposes.

The communication system is also able to communicate with other networks, such as a public switched telephone network or the Internet 112. The communication network may also be able to support the usage of cloud services. It should be appreciated that (e)NodeBs or their functionalities may be implemented by using any node, host, server or access point etc. entity suitable for such a usage.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device.

The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

It should be understood that, in FIG. 1, user devices are depicted to include 2 antennas only for the sake of clarity. The number of reception and/or transmission antennas may naturally vary according to a current implementation.

Further, although the apparatuses have been depicted as single entities, different units, processors and/or memory units (not all shown in FIG. 1) may be implemented.

It is obvious for a person skilled in the art that the depicted system is only an example of a part of a radio access system and in practise, the system may comprise a plurality of (e)NodeBs, the user device may have an access to a plurality of radio cells and the system may comprise also other apparatuses, such as physical layer relay nodes or other network elements, etc. At least one of the NodeBs or eNodeBs may be a Home(e)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The (e)NodeB 108 of FIG. 1 may provide any kind of these cells. A cellular radio system may be implemented as a multilayer network including several kinds of cells. Typically, in multilayer networks, one node B provides one kind of a cell or cells, and thus a plurality of node Bs are required to provide such a network structure.

A hybrid-automatic repeat request (HARQ) is a feature to enhance the performance of packet data transmission. Usually, the HARQ controls and initiates packet retransmission on layer 1 (physical layer), to reduce retransmission delay caused by higher layer transmission. In the case of a link error, caused for instance by interference, a receiving entity may request retransmission of corrupted data packets. HARQ is a “stop and wait” protocol of a nature: a subsequent transmission may take place only after receiving an ACK/NACK from a receiving entity.

Long term evolution (LTE) and long term evolution advanced (LTE-A) have been defined to accommodate both paired spectrum for Frequency division duplex, FDD and unpaired spectrum for Time division duplex, TDD operation. LTE-TDD is also known as TD-LTE. One design target has been to maximize commonality between the LTE-TDD and LTE-FDD to minimize joint standardization and implementation effort, and to maximize compatibility, and thus coexistence of these two LTE modes in a same communication system. Additionally, the LTE-TDD is made compatible also with Time division synchronous code division multiple access (TD-SCDMA).

One of the advantages of the LTE TDD is the option to dynamically change the up and downlink balance and characteristics according to load conditions. Seven uplink/downlink configurations have been defined in the LTE-TDD specifications which use either 5 ms or 10 ms switch-point periodicities. In the case of the 5 ms switch-point periodicity, a “special” subframe exists in both half frames. Whereas in the case of the 10 ms periodicity, certain subframe exists in a first half frame only. Table 1 below shows uplink/downlink configuration patterns for the TD-LTE (Rel-8/9/10) which is shown herein as an example.

These configuration patterns are semi-static. One type of an LTE frame has an overall length of 10 ms comprising two half frames which may be split into five subframes.

TABLE 1

| | Switching- | | | | | | | | | | |
|---|---|---|---|---|---|---|---|---|---|---|---|
| UL/DL | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, D corresponds to downlink transmission, U to uplink transmission and S is a “special” subframe used for instance for providing needed switching time between uplink and downlink transmissions. In the Table 1 timing diagram, a frame is depicted as being divided into 10 subframes each of 1 ms numbered from 0 to 9 and a subframe pattern is thought to be repeated as many times as needed.

The technical specification herein referred to is 3GPP TS 36.211 (frame structure type 2). The selected configuration pattern is usually chosen and conveyed to a user device by a network element.

In current LTE-TDD releases, dynamic uplink/downlink configuration is not yet provided. So far, uplink/downlink switching-points need to be coordinated across a network involved. At the moment, dynamic uplink/downlink resource allocation is a candidate feature for release 11. It is believed that the dynamic uplink/downlink allocation may provide significant throughput gains.

Patent application publication WO 2010/049587 presents one proposal for dynamic allocation of certain uplink and downlink subframes for the LTE-TDD, wherein interference-sensitive control channels are protected from flexible allocation (“fixed subframes”) while other frames are suitable for such a usage (“flexible subframes”). Table 2 illustrates subframes subjected to flexible uplink/downlink allocation:

TABLE 2

| | Switching- | | | | | | | | | | |
|---|---|---|---|---|---|---|---|---|---|---|---|
| UL/DL | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |
| Flex | 5 ms | D | S | U | F | F | D | S | U | F | F |

In Table 2, D corresponds to downlink transmission, U to uplink transmission, S is a “special” subframe used for instance for providing needed switching time between uplink and downlink transmissions and F denotes a flexible subframe. In the Table 2 timing diagram, a frame is depicted as being divided into 10 subframes each of 1 ms numbered from 0 to 9 and a subframe pattern is thought to be repeated as many times as needed.

WO 2010/049587 is taken herein as a reference as to defining subframes suitable for flexible configuration. Subframes suitable for flexible configuration are chosen in a purpose to protect critical control signals from cross-link interference.

However, WO 2010/049587 lefts open how uplink/downlink timing and support for HARQ functionality can possibly be arranged in practice.

Some embodiments suitable for uplink/downlink HARQ design are disclosed in further details in relation to FIG. 2.

The embodiment of FIG. 2 is usually related to a user device, home node, relay node, web stick, server, host, node or other corresponding entity. The embodiment begins in block 200.

In block 202, more than one subframes are chosen from subframes targeted to at least two of the following: physical uplink control channel (PUCCH) acknowledgement/no-acknowledgement (ACK(NACK) signaling, physical hybrid automatic repeat request indicator channel (PHICH) acknowledgement/no-acknowledgement (ACK/NACK) signaling, physical uplink shared channel (PUSCH) resource allocation grant signaling, physical downlink shared channel (PDSCH) resource allocation grant signaling, and a periodic signaling pattern is formed to obtain a flexible subframe configuration for uplink and downlink signaling.

The periodic signaling pattern may be used for hybrid automatic repeat request signalling timing, uplink hybrid automatic repeat request process number, downlink hybrid automatic repeat request process number, uplink scheduling timing and/or downlink scheduling timing. HARQ timing may include PUCCH ACK/NACK timing (timing between downlink shared channel and uplink ACK/NACK transmitted on PUCCH), PHICH ACK/NACK timing (timing between uplink shared channel and downlink ACK/NACK transmitted on PHICH). Uplink/downlink scheduling timing may be in relation to timing between scheduling grant transmitted on PDCCH and the corresponding uplink/downlink data transmission on PUSCH/PDSCH. It should also be understood that an uplink/downlink scheduling grant may include several information elements subject to different timing relationship.

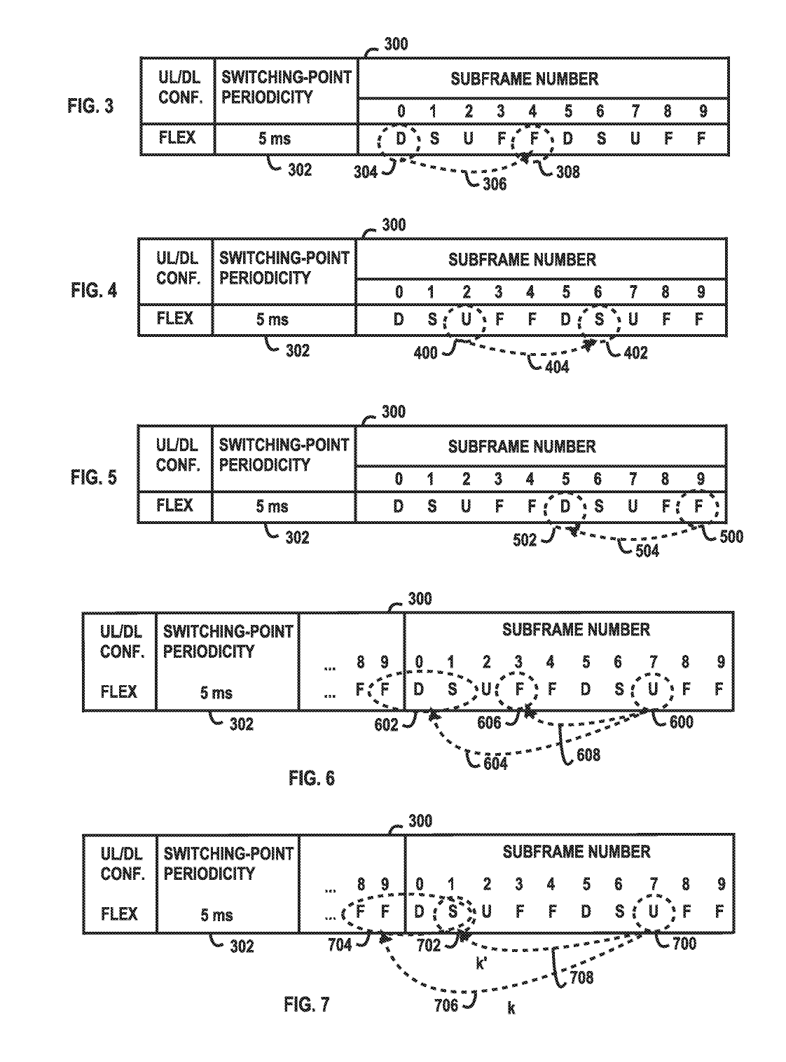

The flexible subframe configuration may include uplink subframes, downlink submframes, “special” subframes and flexible subframes for uplink and downlink signaling. Some examples of the flexible subframe configuration are explained in further detail below by means of FIGS. 3 to 7. In the examples, the periodicity of signaling patterns are 5 ms, but is may also be 10 ms. In the case of the periodicity is 10 ms, flexible subframe configuration may be formed correspondingly to the 5 ms case.

The flexible subframe configuration may comprise subframes which do not include following signaling: physical uplink control channel acknowledgement/no-acknowledgement signaling, physical hybrid automatic repeat request indicator channel acknowledgement/no-acknowledgement signaling, physical uplink shared channel resource allocation grant signaling and/or physical downlink shared channel resource allocation grant signaling. In other words, the subframes may be protected from the signaling listed above.

Additionally, uplink and downlink signaling may be carried out in a user-specific manner. For instance, if flexible configuration is applied in a current TDD network, flexible configuration capable user devices camping in the network in a “non-flexible mode” may first adapt existing cell-specific uplink and/or downlink configuration. When a node detects their capability to support flexible configuration, the node may carry out flexible configuration in a user-specific manner as a part of radio resource control reconfiguration. Flexible configuration may also be used to cell-specific control signaling.

In the following, implementation examples of hybrid automatic repeat request (HARQ) and timing design for flexible uplink and/or downlink configuration (“flex configuration” or “flex TDD configuration”) are explained by using configurations of Table 1 whose switching-point periodicity is 5 ms.

In one example, HARQ signaling (timing) corresponding to uplink/downlink time division duplex configuration “0” (may also be called uplink heavy configuration) is selected for all uplink related signaling in such a manner that PUSCH signaling, PHICH ACK/NACK signaling and PUSCH power control (PC) signaling are scheduled to subframes based on uplink/downlink configuration “0” and the number of HARQ processes for uplink HARQ is defined according to uplink/downlink configuration “0” which supports seven HARQ processes.

In another example, HARQ signaling and timing corresponding to downlink configuration “2” (may also be called downlink heavy configuration) is selected for all downlink related signaling in such a manner that physical uplink control channel (PUCCH) and downlink ACK/NACK signaling are scheduled to subframes based on uplink/downlink time division duplex configuration “2” and the number of HARQ processes for downlink HARQ is defined according to uplink/downlink configuration “2” which supports ten HARQ processes.

In yet another example, timing corresponding to (uplink) downlink association index (DAI) included in downlink control information (DCI) format 0 is introduced and/or timing corresponding to downlink ACK/NACK signaling is modified to better match with uplink DAI signaling.

It should be appreciated that proposed subframe designs are aimed to be backwards compatible to earlier LTE-TDD releases, such as 8, 9 and 10.

In Table 3, an example of a timing diagram for HARQ processes corresponding to LTE-TDD subframes for flexible HARQ configuration, is shown. Table 3 is based on the last row showing flexible subframes of Table 2.

TABLE 3

| | Subframe number | | | | | | | | | |
|---|---|---|---|---|---|---|---|---|---|---|
| | 0 | 1 | 2 | 3 | 4 | 5 | 6 | 7 | 8 | 9 |
| | D | S | U | F | F | D | S | U | F | F |
| UL | | | 1 | 2 | 3 | | | 4 | 5 | 6 |
| HARQ | | | | | | | | | | |
| DL | 1 | 2 | | 3 | 4 | 5 | 6 | | 7 | 8 |
| HARQ | | | | | | | | | | |
| UL | | | 7 | 1 | 2 | | | 3 | 4 | 5 |
| HARQ | | | | | | | | | | |
| DL | 9 | 10 | | 1 | 2 | 3 | 4 | | 5 | 6 |
| HARQ | | | | | | | | | | |

The timing diagram of Table 3 is an example of a periodic signaling pattern to obtain flexible subframe configuration for hybrid automatic repeat request (HARQ) signaling.

In the following, some signaling proposals are shown in further details by means of FIGS. 3 to 7. In the Figures, D corresponds to downlink transmission, U to uplink transmission, S is a “special” subframe used for instance for providing needed switching time between uplink and downlink transmissions and F denotes a flexible subframe. A frame is depicted as being divided into 10 subframes each of 1 ms numbered from 0 to 9 and a subframe pattern is thought to be repeated as many times as needed.

In the examples of FIGS. 3 to 5, signaling timing corresponding to TDD configuration “0” (see Table 2) is selected for all uplink related signaling corresponding to a flexible (FLEX) configuration.

FIG. 3 shows an example of PUSCH triggering for flexible configuration. This example of a periodic signaling pattern to obtain a flexible subframe configuration 300 has switching-point periodicity of 5 ms 302. Physical uplink shared channel (PUSCH) signalling is scheduled to a physical hybrid automatic repeat request indicator channel (PHICH) or uplink grant signaling subframe suitable for flexible configuration. That is shown by an arrow 306 illustrating how downlink transmission originally in subframe 304 is placed to provide PUSCH triggering in flexible subframe 308.

FIG. 4 shows an example of PHICH timing for flexible configuration. This example of a periodic signaling pattern to obtain flexible subframe configuration 300 has switching-point periodicity of 5 ms 302. Physical hybrid automatic repeat request indicator channel (PHICH) signaling carrying ACK/NACK in relation to uplink subframe 400 is scheduled to special subframe 402. Timing relationship is shown by arrow 404.

FIG. 5 shows an example of PUSCH power control commands signaling for flexible configuration. FIG. 5 depicts an example of a periodic signaling pattern to obtain flexible subframe configuration 300. Physical uplink shared channel (PUSCH) power control (PC) commands in relation to subframe 500 are carried by downlink subframe 502. Timing relationship is shown by arrow 504.

FIG. 6 shows an example wherein signaling timing corresponding to TDD configuration “2” (see Table 2) is selected for all downlink related signaling. This example shows PUCCH ACK/NACK timing for flexible configuration. PUCCH ACK/NACK signaling conveyable via uplink subframe 600 includes one or more of subframes 602 including one flexible subframe from a previous subframe, and one downlink subframe and one special subframe (arrow 604) of a subframe under consideration, and/or in a flexible subframe 606 of the subframe under consideration (arrow 608). It should be appreciated that both PUCCH Format 3 and a channel selection may carry ACK/NACK corresponding to flexible or flex configuration going to be launched in Release 11 of the LTE-TDD specification.

It is appreciated that the principles discussed above are feasible or sufficient for most HARQ signaling cases. However, some special cases exist, where further measures are required. Following the spirit of the signaling design of Rel-8/9/10 LTE-TDD, downlink association index (DAI) bits are needed along with flexible uplink/downlink configuration.

FIG. 7 shows an example of a possible DAI timing design for flex configuration. In the Figure, k′ corresponds to an uplink association index and Table 4 below according to uplink/downlink configuration “2” (see Table 2 and 3) may be used to define k that is a downlink association index for the flex configuration. However, this would result in a predictive scheduler operation, since uplink grant signaling carrying uplink DAI needs to be sent prior to the scheduling of the last possible downlink grant signaling. Hence, a downlink association index may be re-defined as well such that [8,7,4,6] is replaced by [9,8,7,6]. The index to be replaced is marked with double-line in the Table 4.

TABLE 4

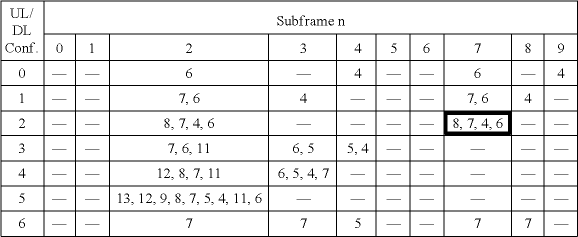

PUCCH ACK/NACK timing with DAI signaling originally placed in uplink subframe 700 is placed in one or more of subframes 704 including two flexible subframes from a previous subframe, and one downlink subframe and one special subframe (arrow 706) of a subframe under consideration, and/or in special subframe 702 of the subframe under consideration (arrow 708).

The embodiment ends in block 204. The embodiment is repeatable in many ways. One example is shown by arrow 206 in FIG. 2.

The steps/points, signaling messages and related functions described above in FIG. 2 are in no absolute chronological order, and some of the steps/points may be performed simultaneously or in an order differing from the given one. Other functions may also be executed between the steps/points or within the steps/points and other signaling messages sent between the illustrated messages. Some of the steps/points or part of the steps/points can also be left out or replaced by a corresponding step/point or part of the step/point.

It should be understood that conveying, transmitting and/or receiving may herein mean preparing a data conveyance, transmission and/or reception, preparing a message to be conveyed, transmitted and/or received, or physical transmission and/or reception itself, etc. on a case by case basis.

An embodiment provides an apparatus which may be any user device, home node, web stick, server, node, host or any other suitable apparatus capable to carry out processes described above in relation to FIG. 2.

FIG. 8 illustrates a simplified block diagram of an apparatus according to an embodiment.

As an example of an apparatus according to an embodiment, it is shown an apparatus 800, such as a user device, relay node or web stick, including facilities in a control unit 804 (including one or more processors, for example) to carry out functions of embodiments according to FIG. 2.

In FIG. 8, block 806 includes parts/units/modules need for reception and transmission, usually called a radio front end, RF-parts, radio parts, etc. This block is optional.

Another example of an apparatus 800 may include at least one processor 804 and at least one memory 802 including a computer program code, the at least one memory and the computer program code configured to, with the at least one processor, cause the apparatus at least to: choose more than one subframes from subframes targeted to at least two of the following: physical uplink control channel acknowledgement/no-acknowledgement signaling, physical hybrid automatic repeat request indicator channel acknowledgement/no-acknowledgement signaling, physical uplink shared channel resource allocation grant signaling, physical downlink shared channel resource allocation grant signaling, and form a periodic signaling pattern to obtain a flexible subframe configuration for uplink and downlink signaling by using the chosen more than one subframes.

Yet another example of an apparatus comprises means for choosing more than one subframes from subframes targeted to at least two of the following: physical uplink control channel acknowledgement/no-acknowledgement signaling, physical hybrid automatic repeat request indicator channel acknowledgement/no-acknowledgement signaling, physical uplink shared channel resource allocation grant signaling, physical downlink shared channel resource allocation grant signaling, and means for forming a periodic signaling pattern to obtain a flexible subframe configuration for uplink and downlink signaling by using the chosen more than one subframes.

Yet another example of an apparatus comprises a chooser configured to choose more than one subframes from subframes targeted to at least two of the following: physical uplink control channel acknowledgement/no-acknowledgement signaling, physical hybrid automatic repeat request indicator channel acknowledgement/no-acknowledgement signaling, physical uplink shared channel resource allocation grant signaling, physical downlink shared channel resource allocation grant signaling, and a forming unit configured to form a periodic signaling pattern to obtain a flexible subframe configuration for uplink and downlink signaling by using the chosen more than one subframes.

It should be understood that the apparatuses may include or be coupled to other units or modules etc, such as radio parts or radio heads, used in or for transmission and/or reception. This is depicted in FIG. 8 as an optional block 806.

Although the apparatuses have been depicted as one entity in FIG. 8, different modules and memory may be implemented in one or more physical or logical entities.

An apparatus may in general include at least one processor, controller or a unit designed for carrying out control functions operably coupled to at least one memory unit and to various interfaces. Further, the memory units may include volatile and/or non-volatile memory. The memory unit may store computer program code and/or operating systems, information, data, content or the like for the processor to perform operations according to embodiments. Each of the memory units may be a random access memory, hard drive, etc. The memory units may be at least partly removable and/or detachably operationally coupled to the apparatus. The memory may be of any type suitable for the current technical environment and it may be implemented using any suitable data storage technology, such as semiconductor-based technology, flash memory, magnetic and/or optical memory devices. The memory may be fixed or removable.

The apparatus may be a software application, or a module, or a unit configured as arithmetic operation, or as a program (including an added or updated software routine), executed by an operation processor. Programs, also called program products or computer programs, including software routines, applets and macros, may be stored in any apparatus-readable data storage medium and they include program instructions to perform particular tasks. Computer programs may be coded by a programming language, which may be a high-level programming language, such as objective-C, C, C++, Java, etc., or a low-level programming language, such as a machine language, or an assembler.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a node device, or a corresponding component, may be configured as a computer or a microprocessor, such as single-chip computer element, or as a chipset, including at least a memory for providing storage capacity used for arithmetic operation and an operation processor for executing the arithmetic operation.

Embodiments provide computer programs embodied on a distribution medium, comprising program instructions which, when loaded into electronic apparatuses, constitute the apparatuses as explained above. The distribution medium may be a non-transitory medium.

Other embodiments provide computer programs embodied on a computer readable medium, configured to control a processor to perform embodiments of the methods described above. The computer readable medium may be a non-transitory medium.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital computer or it may be distributed amongst a number of computers. The computer readable medium may be a non-transitory medium.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, digitally enhanced circuits, other electronic units designed to perform the functions described herein, or a combination thereof. For firmware or software, the implementation may be carried out through modules of at least one chip set (e.g., procedures, functions, and so on) that perform the functions described herein. The software codes may be stored in a memory unit and executed by processors. The memory unit may be implemented within the processor or externally to the processor. In the latter case it may be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

1. An apparatus comprising:
at least one processor and at least one memory including a computer program code, the at least one memory and the computer program code configured to, with the at least one processor, cause the apparatus at least to:
choose more than one subframes from subframes targeted to at least two of the following: physical uplink control channel acknowledgement/no-acknowledgement signaling, physical hybrid automatic repeat request indicator channel acknowledgement/no-acknowledgement signaling, physical uplink shared channel resource allocation grant signaling, physical downlink shared channel resource allocation grant signaling, and
form a periodic signaling pattern to obtain a flexible subframe configuration for uplink and downlink signaling by using the chosen more than one subframes.

2. The apparatus of claim 1, wherein the periodic signaling pattern relates to at least one of the following: hybrid automatic repeat request signalling timing, uplink hybrid automatic repeat request process number, downlink hybrid automatic repeat request process number, uplink scheduling timing and downlink scheduling timing.

3. The apparatus of claim 1, wherein the flexible subframe configuration further comprises: uplink subframes, downlink submframes, special subframes and flexible subframes for uplink and downlink signaling.

4. The apparatus of claim 1, wherein the periodic signaling pattern has periodicity of 5 ms or 10 ms.

5. The apparatus of claim 1, wherein the flexible subframe configuration comprises subframes not comprising at least one of the following: physical uplink control channel acknowledgement/no-acknowledgement signaling, physical hybrid automatic repeat request indicator channel acknowledgement/no-acknowledgement signaling, physical uplink shared channel resource allocation grant signaling and physical downlink shared channel resource allocation grant signaling.

6. The apparatus of claim 1, wherein signaling corresponding to uplink heavy configuration is selected for all uplink signaling.

7. The apparatus of claim 1, wherein signaling corresponding to downlink heavy configuration is selected for all downlink signaling.

8. The apparatus of claim 1, wherein the uplink and downlink signaling are carried out in a user-specific manner.

9. The apparatus of claim 1, wherein signaling timing corresponding to time division duplex configuration “2” is selected for all downlink signaling.

10. The apparatus of claim 1, wherein signaling timing corresponding to time division duplex configuration “0” is selected for all uplink signaling.

11. The apparatus of claim 1, the apparatus comprising a user device, relay node, server, host, node or web stick.

12. (canceled)

13. A method comprising:
choosing more than one subframes from subframes targeted to at least two of the following: physical uplink control channel acknowledgement/no-acknowledgement signaling, physical hybrid automatic repeat request indicator channel acknowledgement/no-acknowledgement signaling, physical uplink shared channel resource allocation grant signaling, physical downlink shared channel resource allocation grant signaling, and
forming a periodic signaling pattern to obtain a flexible subframe configuration for uplink and downlink signaling by using the chosen more than one subframes.

14. The method of claim 13, wherein the periodic signaling pattern relates to at least one of the following: hybrid automatic repeat request signalling timing, uplink hybrid automatic repeat request process number, downlink hybrid automatic repeat request process number, uplink scheduling timing and downlink scheduling timing.

15. The method of claim 13, wherein the flexible subframe configuration further comprises: uplink subframes, downlink submframes, special subframes and flexible subframes for uplink and downlink signaling.

16. The method of claim 13, wherein the periodic signaling pattern has a periodicity of 5 ms or 10 ms.

17. The method of claim 13, wherein the flexible subframe configuration comprises subframes not comprising at least one of the following: physical uplink control channel acknowledgement/no-acknowledgement signaling, physical hybrid automatic repeat request indicator channel acknowledgement/no-acknowledgement signaling, physical uplink shared channel resource allocation grant signaling and physical downlink shared channel resource allocation grant signaling.

18. The method of claim 13, further comprising:
selecting signaling corresponding to uplink heavy configuration for all uplink signaling.

19. The method of claim 13, further comprising:
selecting signaling corresponding to downlink heavy configuration for all downlink signaling.

20. The method of claim 13, wherein the uplink and downlink signaling are carried out in a user-specific manner.

21. The method of claim 13, further comprising:
selecting signaling timing corresponding to time division duplex configuration “2” for all downlink signaling.

22. The method of claim 13, further comprising:
selecting signaling timing corresponding to time division duplex configuration “0” for all uplink signaling.

23. (canceled)

24. A computer program embodied on a computer-readable storage medium, the computer program comprising program code for controlling a process to execute a process, the process comprising:
choosing more than one subframes from subframes targeted to at least two of the following: physical uplink control channel acknowledgement/no-acknowledgement signaling, physical hybrid automatic repeat request indicator channel acknowledgement/no-acknowledgement signaling, physical uplink shared channel resource allocation grant signaling, physical downlink shared channel resource allocation grant signaling, and
forming a periodic signaling pattern to obtain a flexible subframe configuration for uplink and downlink signaling by using the chosen more than one subframes.

25. The computer program of claim 24, wherein the periodic signaling pattern relates to at least one of the following: hybrid automatic repeat request signalling timing, uplink hybrid automatic repeat request process number, downlink hybrid automatic repeat request process number, uplink scheduling timing and downlink scheduling timing.

26. The computer program of claim 24, wherein the flexible subframe configuration further comprises: uplink subframes, downlink submframes, special subframes and flexible subframes for uplink and downlink signaling.

27. The computer program of claim 24, wherein the periodic signaling pattern has a periodicity of 5 ms or 10 ms.

28. The computer program of claim 24, wherein the flexible subframe configuration comprises subframes not comprising at least one of the following: physical uplink control channel acknowledgement/no-acknowledgement signaling, physical hybrid automatic repeat request indicator channel acknowledgement/no-acknowledgement signaling, physical uplink shared channel resource allocation grant signaling and physical downlink shared channel resource allocation grant signaling.

29. The computer program of claim 24, further comprising:
selecting signaling corresponding to uplink heavy configuration for all uplink signaling.

30. The computer program of claim 24, further comprising:
selecting signaling corresponding to downlink heavy configuration for all downlink signaling.

31. The computer program of claim 24, wherein the uplink and downlink signaling are carried out in a user-specific manner.

32. The computer program of claim 24, further comprising:
selecting signaling timing corresponding to time division duplex configuration “2” for all downlink signaling.

33. The computer program of claim 24, further comprising:
selecting signaling timing corresponding to time division duplex configuration “0” for all uplink signaling
